(19) United States
(12) Patent Application Publication
(10) Pub. No.: US 2014/0009819 A1
(43) Pub. Date: Jan. 9, 2014

(54) STEREOSCOPIC IMAGE CONTROL MODULE AND STEREOSCOPIC DISPLAY DEVICE

(71) Applicant: HannStar Display Corp., New Taipei City (TW)

(72) Inventors: Hsu-Ho WU, Tainan City (TW); Chia Hua YU, New Taipei City (TW); I Fang WANG, Changhua City (TW); Mu-Kai KANG, Pingtung City (TW); Heng-Cheng TSENG, Budai Township (TW)

(21) Appl. No.: 13/936,024

(22) Filed: Jul. 5, 2013

(30) Foreign Application Priority Data
Jul. 6, 2012 (CN) 201210234181.5

(51) Int. Cl. G02F 1/29

(52) U.S. Cl. CPC G02F 1/292
USPC 359/315

(57) ABSTRACT

A stereoscopic image control module that can be disposed on a display module to form a stereoscopic image display module is provided. The stereoscopic image control module includes a first substrate, a touch composite layer, and a grating composite layer. The first substrate has a first surface and a second surface opposite to the first surface, and the touch composite layer is disposed on at least one of the first surface and the second surface and includes a plurality of touch electrodes. The grating composite layer is disposed on the second surface and includes a plurality of grating control electrodes and a grating layer, wherein the grating control electrodes change a polarity of the grating layer to determine a display mode.

### BACKGROUND OF THE INVENTION

1. Field of the Invention

The present invention generally relates to a stereoscopic image control module and a stereoscopic display device. Particularly, the present invention relates to a stereoscopic display device for displaying images.

2. Description of the Prior Art

As technology is continuously developed, the combination of display technology and touch technique becomes main trend. For example, touch display technology is widely used in mobile phones, tablet computers, ATMs, navigation systems, or other interactive display devices. In general, the touch display device has a touch module and a display module stacking to each other, wherein the touch module and the display module respectively include at least two glass substrates.

It is noted that display technology has presented good performance in flat display field, thus manufacturers further develop in stereoscopic image field. In addition to a touch module and a display module, the conventional touch stereoscopic display device further includes a switching image module; for instance, a grating module having functions of switching 2D (two-dimensional) images and stereoscopic (three-dimensional, 3D) images. Please refer to FIG. 1; FIG. 1 is a cross-sectional view of a conventional touch stereoscopic display device. As shown in FIG. 1, the touch stereoscopic display device 11 includes a touch module 12, a grating module 13, and a display module 14. In practical applications, the touch module 12 includes two glass substrates 111 and a touch unit 121; the grating module 13 includes two glass substrates 111 and a grating unit 131; and the display module 14 includes two glass substrates 111 and a display unit 141. In other words, the touch stereoscopic display device has at least six glass substrates 111, and each glass substrate 111 has a certain thickness, so that the whole thickness is increased and the cost is hard to be decreased.

In addition, the touch module 12, the grating module 13, and the display module 14 are attached by the optical glue 222. However, during the attachment process, yield is easily decreased duo to human factor or manufacturing factor. Furthermore, the optical glue 222 also influences the cost. Moreover, when the yield is decreased, more optical glue 222 will be consumed, thus increasing the cost.

For the above reasons, it is an object to design a stereoscopic display device, which can reduce the cost, decrease the thickness, and increase yield.

### SUMMARY OF THE INVENTION

It is an object of the present invention to provide a stereoscopic image control module, which can reduce the cost and decrease the thickness.

In one aspect, the present invention provides a stereoscopic image control module, which utilizes a common substrate to decrease the thickness.

In another aspect, the present invention provides a stereoscopic image control module, which decreases the use of the glue to increase the yield.

In one further aspect, the present invention provides a stereoscopic image control module, which can integrate structures to decrease the cost.

In yet another aspect, the present invention provides a stereoscopic display device including a display module and the stereoscopic image control module, which is light in weight and thin in size.

In one embodiment, the present invention provides a stereoscopic image control module that can be disposed on a display module. The stereoscopic image control module includes a first substrate, a touch composite layer, and a grating composite layer. The first substrate has a first surface and a second surface opposite to the first surface. The touch composite layer is disposed on at least one of the first surface and the second surface. The touch composite layer includes a plurality of touch electrodes. The grating composite layer is disposed on the second surface; the grating composite layer includes a plurality of grating control electrodes and a grating layer, wherein the grating control electrodes change a polarity of the grating layer to determine a display mode.

In one embodiment, the present invention provides a stereoscopic display device, which includes the stereoscopic image control module and a display module, wherein the display module is disposed corresponding to the stereoscopic image control module.

In comparison with prior arts, the stereoscopic image control module and the stereoscopic display device of the present invention utilize the first substrate serving as a common substrate to decrease the amount of the substrates so as to be light and thin. It is noted that the first substrate is the common substrate of the touch composite layer and the grating composite layer. In other words, the touch composite layer and the grating composite layer jointly utilize the first substrate to dispose components so as to decrease the thickness of the whole module and to effectively decrease the usage rate of glue. It is noted that the stereoscopic image control module improves the manufacturing process to solve problems of cost and yield without influencing touch technology and display technique.

The above and other objects, features and advantages of the present invention will be more clearly understood from the following detailed description taken in conjunction with the accompanying drawings.

### BRIEF DESCRIPTION OF THE DRAWINGS

FIG. 1 is a cross-sectional view of a conventional stereoscopic image device;

FIG. 2 is a cross-sectional view of the embodiment of a stereoscopic image control module and a stereoscopic display device of the present invention;

FIG. 3 is a cross-sectional view of another embodiment of the stereoscopic image control module and the stereoscopic display device of the present invention;

FIG. 4 is a cross-sectional view of another embodiment of the stereoscopic image control module and the stereoscopic display device of the present invention;

FIG. 5 is a cross-sectional view of another embodiment of the stereoscopic image control module and the stereoscopic display device of the present invention;

FIG. 6 is a cross-sectional view of another embodiment of the stereoscopic image control module and the stereoscopic display device of the present invention;

FIG. 7 is a cross-sectional view of another embodiment of the stereoscopic image control module and the stereoscopic display device of the present invention;

FIG. 8 is a cross-sectional view of another embodiment of the stereoscopic image control module and the stereoscopic display device of the present invention;

FIG. 9 is a cross-sectional view of another embodiment of the stereoscopic image control module and the stereoscopic display device of the present invention;

FIG. 10 is a cross-sectional view of another embodiment of the stereoscopic image control module and the stereoscopic display device of the present invention;

FIG. 11 is a cross-sectional view of another embodiment of the stereoscopic image control module and the stereoscopic display device of the present invention;

FIG. 12 is a cross-sectional view of another embodiment of the stereoscopic image control module and the stereoscopic display device of the present invention;

FIG. 13 is a cross-sectional view of another embodiment of the stereoscopic image control module and the stereoscopic display device of the present invention;

FIG. 14 is a cross-sectional view of another embodiment of the stereoscopic image control module and the stereoscopic display device of the present invention; and

FIG. 15 is a cross-sectional view of another embodiment of the stereoscopic image control module and the stereoscopic display device of the present invention.

### DETAILED DESCRIPTION OF THE PREFERRED EMBODIMENT

According to one embodiment, the present invention provides a stereoscopic image control module, which can decrease the cost and the thickness. In the embodiment, the stereoscopic image control module can switch 2D images and stereoscopic (3D) images and is disposed on a display module. In a preferred embodiment, the display module is a flat display device, such as LCD device, OLED device, or other display devices including backlight module type or self-light-emitting type.

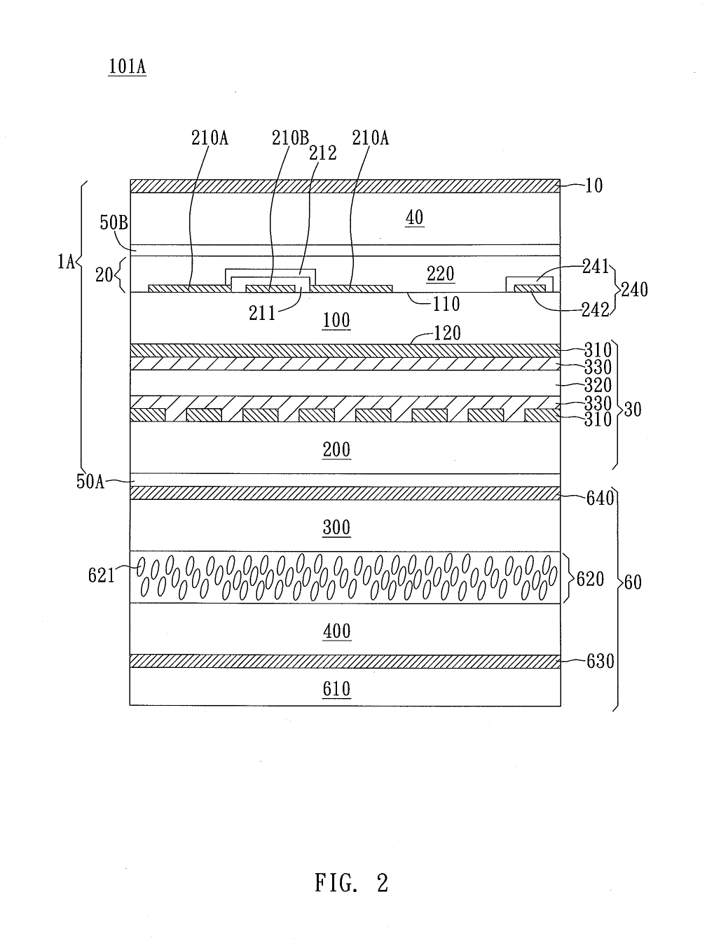

Please refer to FIG. 2; FIG. 2 is a cross-sectional view of the embodiment of a stereoscopic image control module and a stereoscopic display device of the present invention. As shown in FIG. 2, the stereoscopic image control module 1A includes a first substrate 100, a touch composite layer 20, and a grating composite layer 30. The first substrate 100 has a first surface 110 and a second surface 120 opposite to the first surface 110. The touch composite layer 20 is disposed on at least one of the first surface 110 and the second surface 120; the touch composite layer 20 includes a plurality of touch electrodes 210A/210B. In the embodiment, the first substrate 100 is a transparent substrate, preferably a transparent glass substrate, but not limited to the embodiment.

In the embodiment, the touch composite layer 20 is selected to be disposed on the first surface 110 and includes the touch electrodes 210A/210B. The touch electrodes 210A and the touch electrodes 210B are disposed on the first surface 110 and distributed along a transverse direction and a longitudinal direction, wherein an extending direction of the touch electrodes 210A distributed along the transverse direction is perpendicular to an extending direction of the touch electrodes 210B distributed along the longitudinal direction, so that the touch electrodes 210A and the touch electrodes 210B are interlaced to form a touch mesh surface for achieving full-scale touch effect. In addition, the touch composite layer 20 further has a plurality of insulating portions 211 and a plurality of bridge portions 212. It is noted that the insulating portions 211 are disposed between the touch electrodes 210A and the touch electrodes 210B and capable of preventing the touch electrodes 210A from electrically connecting the touch electrodes 210B. In practical applications, the touch electrodes 210A are discrete electrodes, and the bridge portions 212 can connect the touch electrodes 210A disposed along the extending direction or connect the touch electrodes 210B disposed along the extending direction longitudinal. In addition, the touch electrodes 210A/210B can be a transparent conductive film and its material can include ITO (Indium Tin Oxide), the bridge portions 212 can be a transparent conductive film and its material can include ITO or metal conductive film and its material can include of one or more of aluminum (Al), chromium (Cr), molybdenum (Mo), or copper (Cu), but not limited to the embodiment.

As shown in FIG. 2, the touch composite layer 20 further includes a fan-out unit 240, wherein the fan-out unit 240 is disposed on a side of the first surface 110 and is connected to the corresponding touch electrodes 210A/210B. The fan-out unit 240 preferably outputs a plurality of touch data detected by the touch electrodes 210A/210B, and the area of the fan-out unit 240 on the first surface 110 is less than the area of the touch electrodes 210A/210B, so that the stereoscopic image control module 1A utilizes the fan-out unit 240 to concentrate and output the touch data. In particular, each fan-out unit 240 includes a conductor portion 241 and an output electrode 242, wherein the conductor portion 241 can bridge or connect the touch electrodes 210A/210B and the output electrode 242, and the output electrode 242 is used for outputting the touch data. In practical applications, the conductor portion 241 is a metal conductor; the material of the output electrode 242 can be the same as the material of the touch electrodes 210A/210B.

In addition, the touch composite layer 20 further includes a first protection layer 220, wherein the first protection layer 220 covers the touch electrodes 210A/210B disposed on the first surface 110. In practical applications, the first protection layer 220 can avoid the touch electrodes 210A/210B to be damaged. In the embodiment, the first protection layer 220 can be an insulating oxide layer and its material can include SiOx (Silicon Oxide), or other inorganic or organic insulating materials.

As shown in FIG. 2, the grating composite layer 30 is disposed on the second surface 120 opposite to the first surface 110 and preferably includes a second substrate 200, a plurality of grating control electrode 310, a grating layer 320, and at least one alignment layer 330, wherein the grating control electrodes 310 change the polarity or the orientation of the grating layer 320 to switch and determine the display mode. In a preferred embodiment, the display mode includes a flat display mode and a stereoscopic display mode. In other words, the stereoscopic image control module 1A utilizes the grating composite layer 30 to determine the display mode so as to switch flat images (2D) and stereoscopic images (3D).

As shown in FIG. 2, the second substrate 200 faces the second surface 120 of the first substrate 100, wherein some of the grating control electrodes 310 are disposed on the second substrate 200, and the rest of the grating control electrodes 310 are disposed on the second surface 120. An extending direction of the grating control electrodes 310 on the second substrate 200 is preferably perpendicular to an extending direction of the grating control electrode 310 on the second surface 120. In the embodiment, the alignment layer 330 is preferably disposed on the grating control electrodes 310 to control an orientation of the grating layer 320. The grating layer 320 is disposed between the second surface 120 and the second substrate 200. In particular, the grating layer 320 is disposed in a space clamped by the alignment layers 330 that are disposed face to face. The material of the grating layer 320 is preferably LC (liquid crystal) material. In practical applications, the rotating angle of the grating layer 320 is changed according to voltage of the grating control electrode 310 so as to show different display effect.

For the above descriptions, in the embodiment, the touch composite layer 20 and the grating composite layer 30 utilize the first substrate 100 serving as the common substrate so as to decrease the amount of substrates, effectively decreasing the thickness. In addition, the amount of substrates is decreased, so that the attachment/gluing process is also decreased so as to increase production efficiency and decrease defect rate. In other words, the stereoscopic image control module 1A of the present invention utilizes the common substrate structure to improve the production efficiency and decrease the cost to achieve light and thin products.

As shown in FIG. 2, the stereoscopic image control module 1A is used with the display module 60, wherein the display module 60 is disposed corresponding to the stereoscopic image control module 1A. The stereoscopic display device 101A includes the stereoscopic image control module 1A and the display module 60. In the embodiment, the display module 60 utilizes the optical glue layer 50A to connect with the grating composite layer 30. For example, the optical glue layer 50A can be optically clear adhesives (OCA), liquid optically clear adhesives (LOCA), frame adhesives, or other adhesive materials or films. The display module 60 preferably includes a third substrate 300, a fourth substrate 400, a backlight module 610, an optical modulation layer 620, a first polarizing layer 630, and a second polarizing layer 640, wherein the third substrate 300 is disposed on the second substrate 200 and connected to the stereoscopic image control module 1A. In the embodiment, the third substrate 300 is attached onto the second substrate 200 by the optical glue layer 50A. In addition, the fourth substrate 400 faces the third substrate 300, wherein the optical modulation layer 620 is disposed between the fourth substrate 400 and the third substrate 300, and the backlight module 610 is disposed corresponding to the fourth substrate 400.

The first polarizing layer 630 is disposed between the fourth substrate 400 and the backlight module 610 and changes the polarity of the backlight. In addition, the second polarizing layer 640 is disposed between the second substrate 200 and the third substrate 300 and changes the polarity of the images. In the embodiment, the second polarizing layer 640 is disposed between the optical glue layer 50A and the third substrate 300. In practical applications, material of the first polarizing layer 630 and the second polarizing layer 640 can be polyvinyl alcohol (PVA) or other polarizing materials.

In practical applications, the backlight module 610 is disposed corresponding to the fourth substrate 400 and transmits light toward the fourth substrate 400 uniformly, and the first polarizing layer 630 converts light from unpolarized light into polarized light. In addition, the optical modulation layer 620 has a plurality of optical units 621, wherein the optical units can adjust color level of the light and displays the images. For example, the optical units 621 can be liquid crystal molecules. Light is modulated by controlling rotation of the optical units 621, and the second polarizing layer 640 controls output of light.

As shown in FIG. 2, the stereoscopic image control module 1A further includes a polarizing layer 10, a transparent optical layer 40, and an optical glue layer 50B. It is noted that the optical glue layer 50B is disposed between the touch composite layer 20 and the transparent optical layer 40, wherein the transparent optical layer 40 is attached onto the touch composite layer 20 by means of the optical glue layer 50B. In addition, the optical glue layer 50B can be optically clear adhesives (OCA), liquid optically clear adhesives (LOCA), frame adhesives, or other adhesive films. In the embodiment, the optical glue layer 50B is the liquid optically clear adhesive, but not limited thereto. As shown in FIG. 2, the transparent optical layer 40 is disposed between the touch composite layer 20 and the polarizing layer 10, wherein the transparent optical layer 40 can be a lens layer, a transparent glue layer, or arbitrary transparent layer. In the embodiment, the transparent optical layer 40 is the lens layer and is preferably cover lens or tempered glass. It is noted that the polarizing layer 10 is disposed outside of the touch composite layer 20. In particular, the polarizing layer 10 is pasted on the transparent optical layer 40 to filter and restrain reflected light so as to increase image quality.

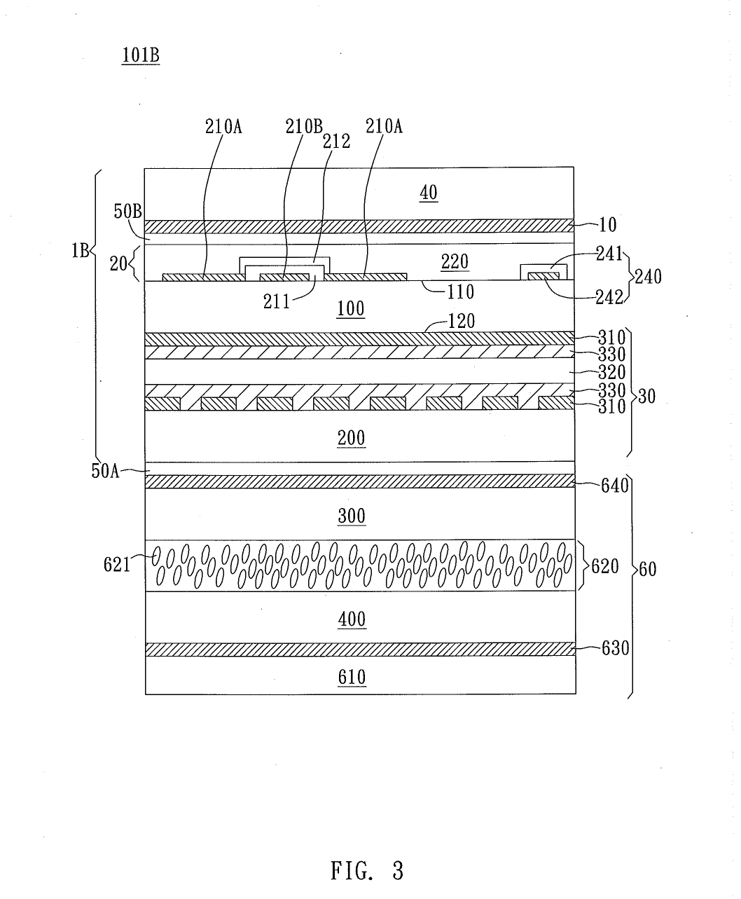

Please refer to FIG. 3; FIG. 3 is a cross-sectional view of another embodiment of the stereoscopic image control module 1B and the stereoscopic display device 101B of the present invention. As shown in FIG. 3, in comparison with the stereoscopic image control module 1A, the transparent optical layer 40 of the stereoscopic image control module 1B is disposed outside of the polarizing layer 10. In other words, the stereoscopic image control module 1B utilizes the transparent optical layer 40 serving as a touch interface for user, wherein the transparent optical layer 40 is preferably a cover lens or tempered glass, so that the user feels smoother touch when touching so as to increase manipulation quality and touch perception.

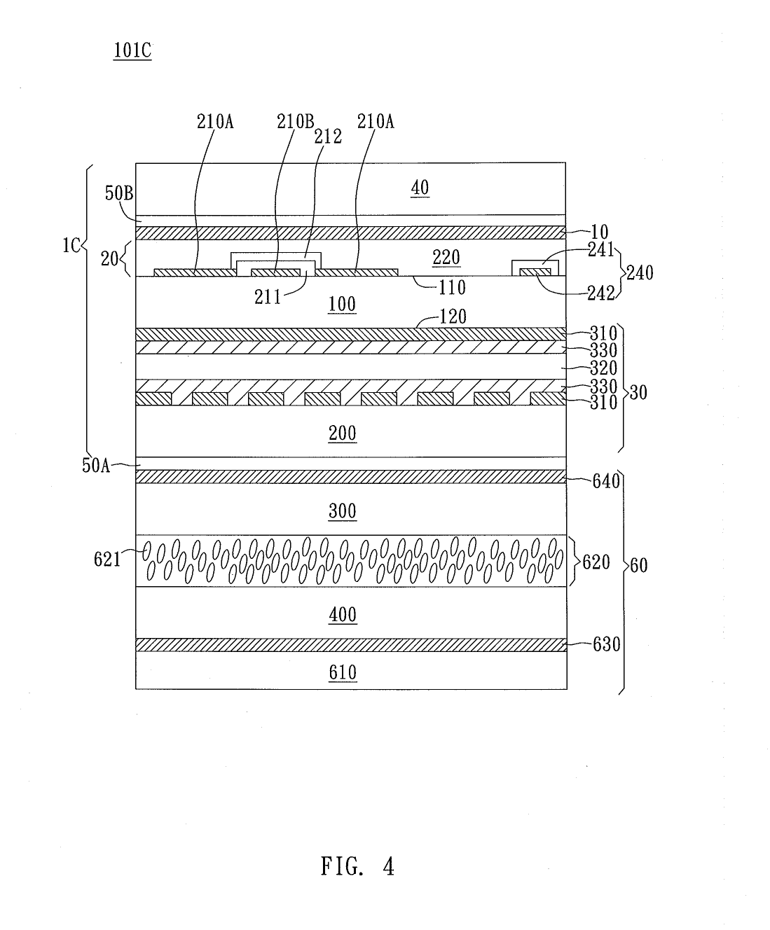

Please refer to FIG. 4; FIG. 4 is a cross-sectional view of another embodiment of the stereoscopic image control module 1C and the stereoscopic display device 101C of the present invention. As shown in FIG. 4, in comparison with the stereoscopic image control module 1B, the optical glue layer 50B of the stereoscopic image control module 1C is disposed between the transparent optical layer 40 and the polarizing layer 10. In practical processes, the optical glue layer 50B easily generates macula phenomena when directly contacting the first protection layer 220. Furthermore, in the embodiment, the optical glue layer 50B of the stereoscopic image control module 1C does not directly contact the first protection layer 220, so the optical glue layer 50B does not easily generate macula phenomena. In other words, the stereoscopic image control module 1C not only has better manipulation quality but also provides better display quality.

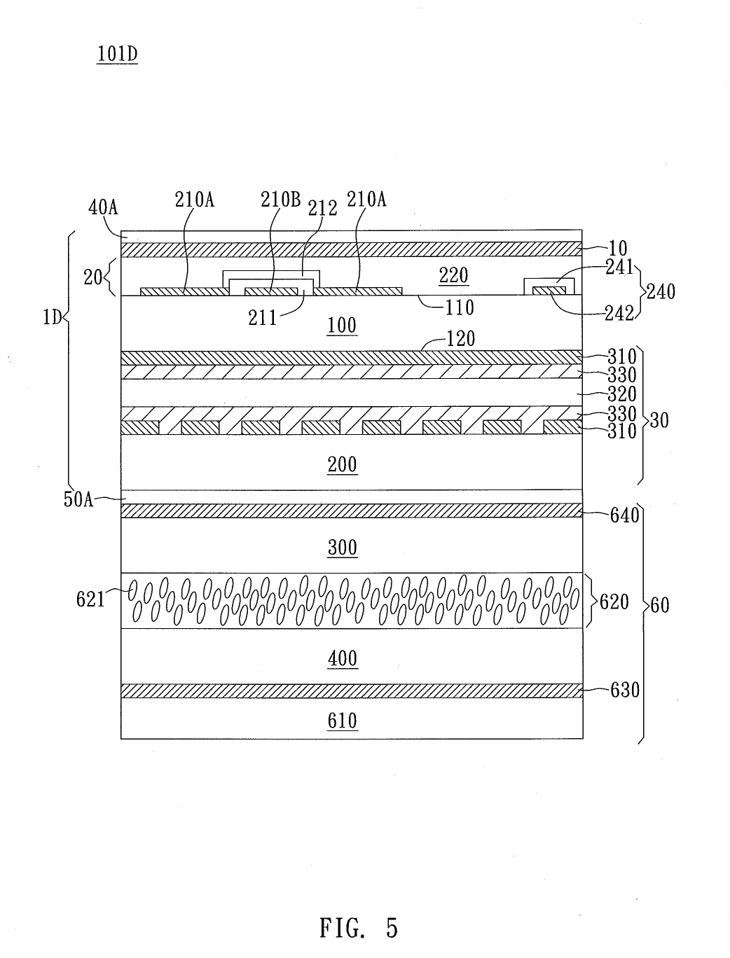

Please refer to FIG. 5; FIG. 5 is a cross-sectional view of another embodiment of the stereoscopic image control module 1D and the stereoscopic display device 101D of the present invention. As shown in FIG. 5, compared to the stereoscopic image control modules 1A˜1C, the stereoscopic image control module 1D does not have the optical glue layer 50B, so the macula phenomena will not easily occur. In the embodiment, the polarizing layer 10 is directly formed on the touch composite layer 20, and the transparent optical layer 40A is disposed outside of the polarizing layer 10. In the embodiment, the transparent optical layer 40A is a transparent adhesive film and has thinner thickness so as to be light and thin. For example, the transparent optical layer 40A can be a transparent plastic case, a transparent colloid film, or other thin optical materials. In other words, the stereoscopic image control module 1D can decrease the cost and substantially decrease the thickness of the product. It is noted that the touch composite layer 20 as shown in FIGS. 2, 3, 4, and 5 are usually called Single-Sided ITO (SITO) structure.

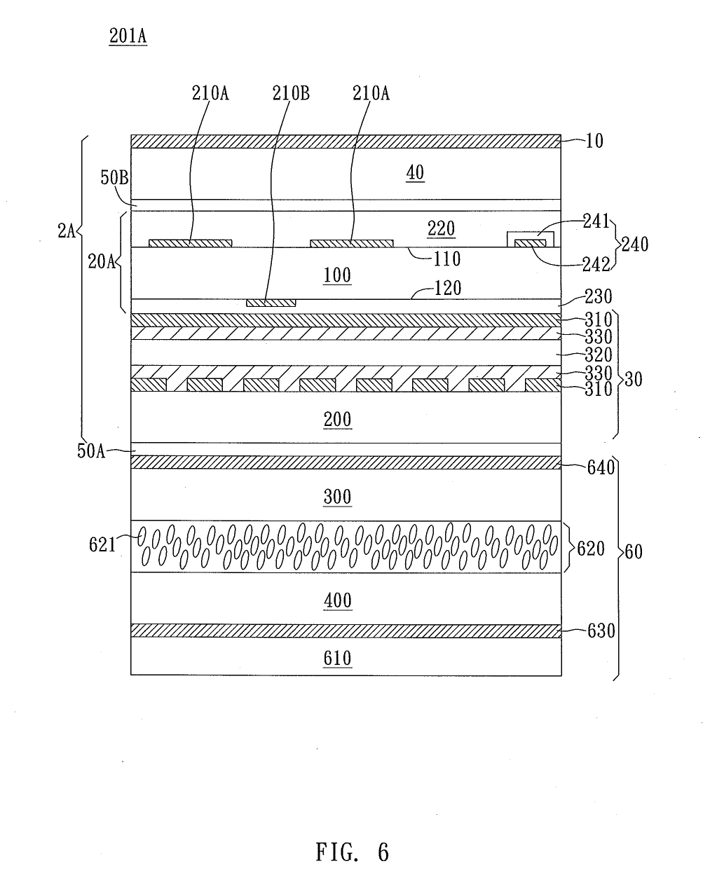

Please refer to FIG. 6; FIG. 6 is a cross-sectional view of another embodiment of the stereoscopic image control module 2A and the stereoscopic display device 201A of the present invention. As shown in FIG. 6, the touch composite layer 20A of the stereoscopic image control module 2A has a different assembly structure, wherein some of the touch electrodes (e.g. 210A) are disposed on the first surface 110, and the rest of the touch electrodes (e.g. 210B) are disposed on the second surface 120 of the first substrate 100. Furthermore, the touch electrodes 210A/210B which are in the transverse direction and the longitudinal direction are respectively disposed on the first surface 110 and the second surface 120, wherein the extending direction of the touch electrodes 210A in the transverse direction is perpendicular to the extending direction of the touch electrodes 210B in the longitudinal direction. It is noted that the extending direction of the touch electrodes 210A disposed on the first surface 110 is perpendicular to the extending direction of the touch electrodes 210B disposed on the second surface 120. In other words, compared to the stereoscopic image control module 1A of FIG. 2, the touch electrodes 210A and the touch electrodes 210B of the touch composite layer 20A are respectively disposed on the first surface 110 and the second surface of the first substrate 100, not only having touch mechanism, but also avoiding the short circuit due to the electrical connection between the touch electrodes 210A and the touch electrodes 210B.

It is noted that the stereoscopic image control module 2A has the second protection layer 230, wherein the second protection layer 230 covers the touch electrodes 210B on the second surface 120 so as to avoid the short circuit of the touch electrodes 210B. In the embodiment, the second protection layer 230 connects the grating composite layer 30 so as to avoid the touch electrodes 210B on the second surface 120 to be contacted by the grating control electrodes 310, further avoiding the short circuit between the touch electrodes 210B and the grating control electrodes 310.

In addition, the assembly structure of the optical glue layer 50B, the polarizing layer 10, and the transparent optical layer 40 is the same as the assembly structure of the stereoscopic image control module 1A and not elaborated hereinafter.

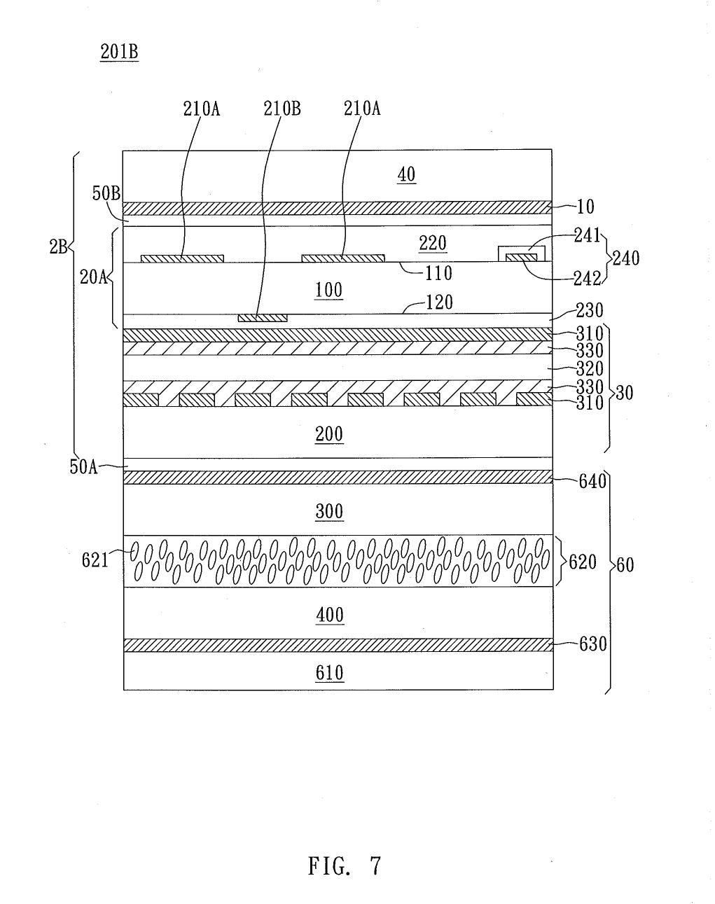

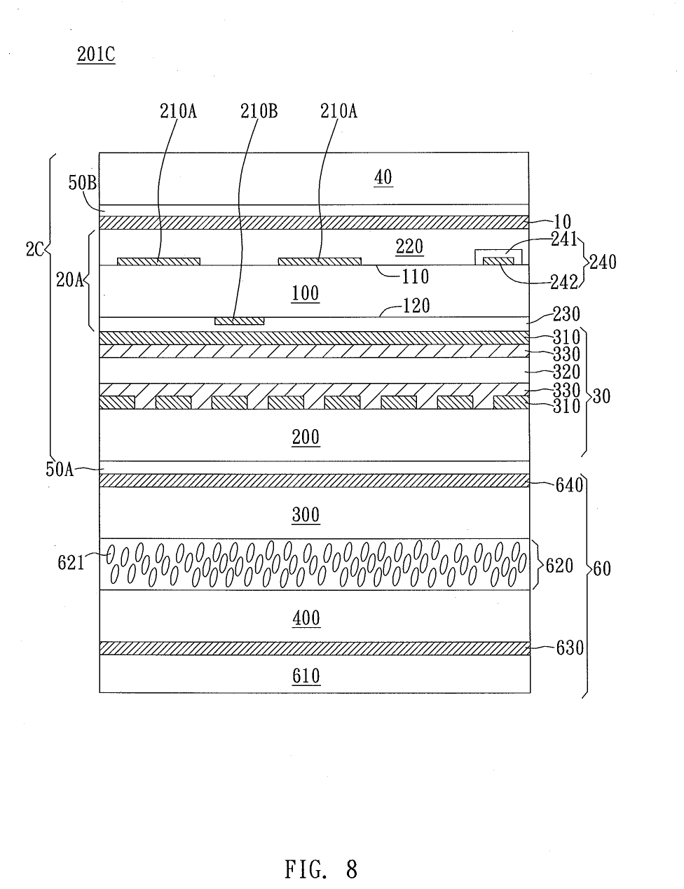

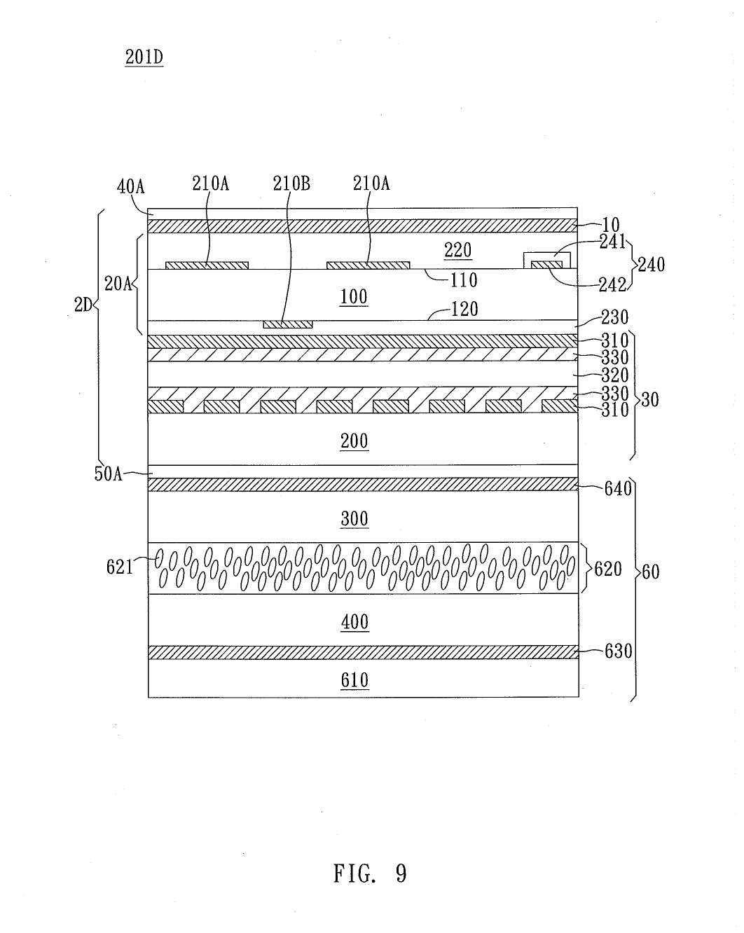

Please refer to FIGS. 7, 8, and 9, wherein FIGS. 7, 8, and 9 are cross-sectional view of embodiments of the stereoscopic image control modules 2B/2C/2D and the stereoscopic display devices 201B/201C/201D of the present invention. It is noted that the touch composite layer 20A of the stereoscopic image control module 2B/2C of FIGS. 7 and 8 is the same as the touch composite layer 20A of the stereoscopic image control module 2A; the assembly structure of the optical glue layer 50B, the polarizing layer 10, and the transparent optical layer 40 of the stereoscopic image control module 2B/2C is the same as the assembly structure of the stereoscopic image control module 1B and not elaborated hereinafter. In addition, the stereoscopic image control module 2D of FIG. 9 has the same touch composite layer 20A of the stereoscopic image control module 2A; the assembly structure of the polarizing layer 10 and the transparent optical layer 40A of the stereoscopic image control module 2D is the same as the assembly structure of the stereoscopic image control module 1D and not elaborated hereinafter. In other words, compared to the embodiments of FIGS. 2 through 5, the embodiments of FIGS. 6 through 9 disclose the stereoscopic image control module having another touch structure. It is noted that the touch composite layer 20A as shown in FIGS. 6, 7, 8, and 9 are usually called Double-Sided ITO (DITO) structure.

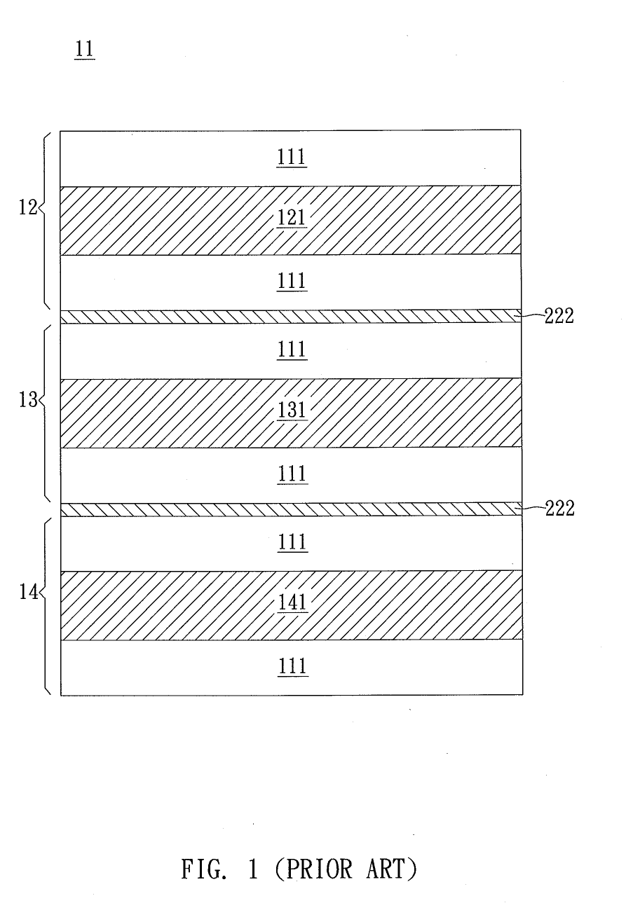

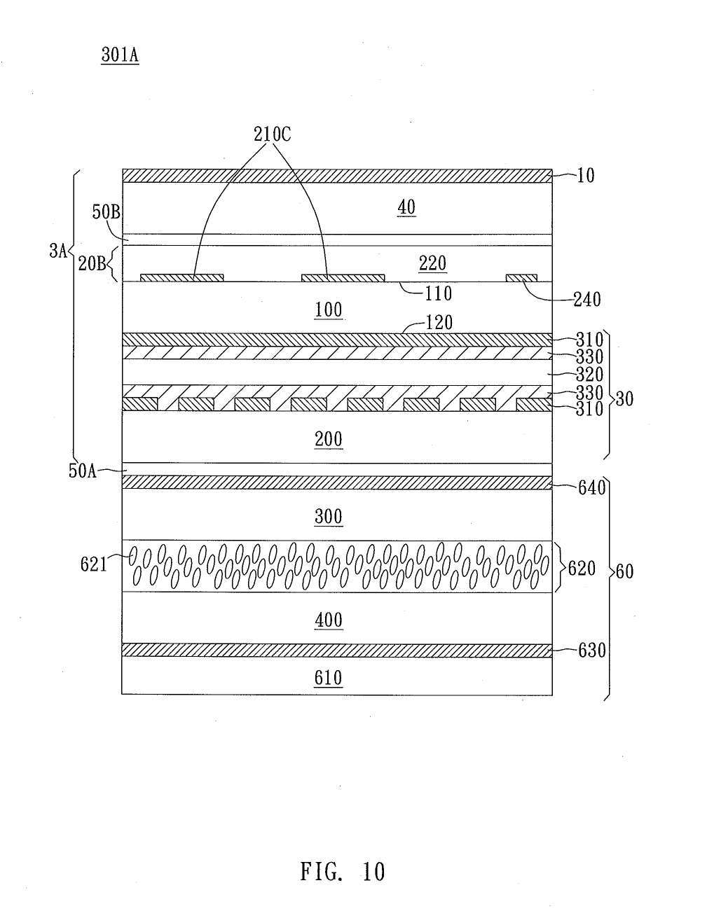

Please refer to FIG. 10; FIG. 10 is a cross-sectional view of another embodiment of the stereoscopic image control module 3A and the stereoscopic display device 301A of the present invention. As shown in FIG. 10, the stereoscopic image control module 3A has a touch composite layer 20B, wherein the touch electrodes 210C are disposed on the first surface 110. In particular, the touch electrodes are implanted on the first surface 110 by laser etching. It is noted that the touch electrodes 210C perform the detection in a touch area manner, so that the touch composite layer 20B does not utilize the insulating portions 211 and the bridge portions 212 of FIG. 1 but utilizes the fan-out unit 240 to connect the touch electrodes 210C. In other words, compared to the touch composite layers 20 and 20A, the touch composite layer 20B has a simpler structure and is only disposed on a single surface to achieve the touch function. In addition, the assembly structure of the optical glue layer 50B, the polarizing layer 10, and the transparent optical layer 40 of the stereoscopic image control module 3A is the same as the assembly structure of the stereoscopic image control module 1A and not elaborated hereinafter.

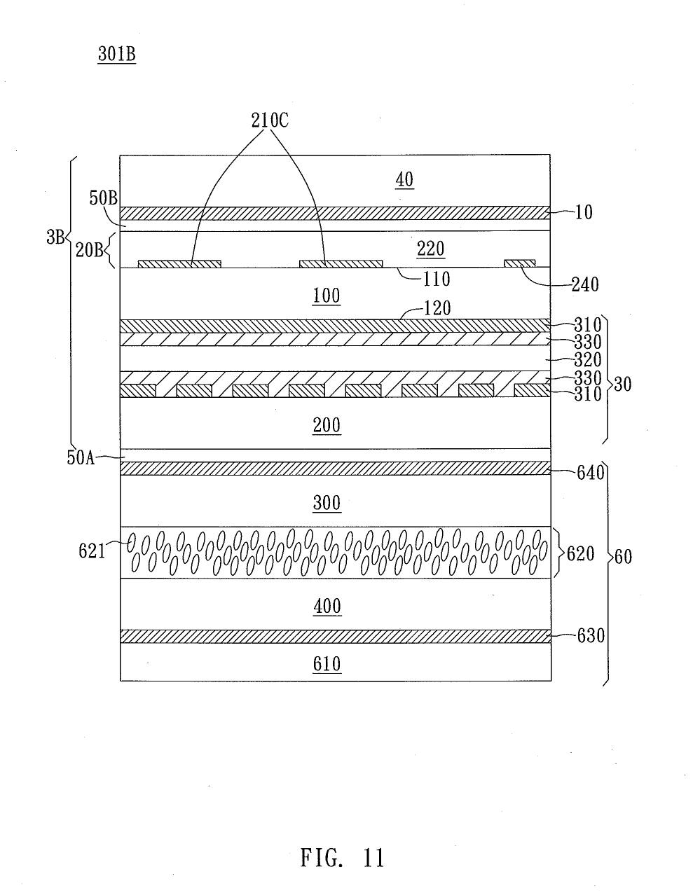

Please refer to FIG. 11; FIG. 11 is a cross-sectional view of another embodiment of the stereoscopic image control module 3B and the stereoscopic display device 301B of the present invention. As shown in FIG. 11, the stereoscopic image control module 3B has the touch composite layer 20B; the assembly structure of the optical glue layer 50B, the polarizing layer 10, and the transparent optical layer 40 of the stereoscopic image control module 3B is the same as the assembly structure of the stereoscopic image control module 1B and not elaborated hereinafter.

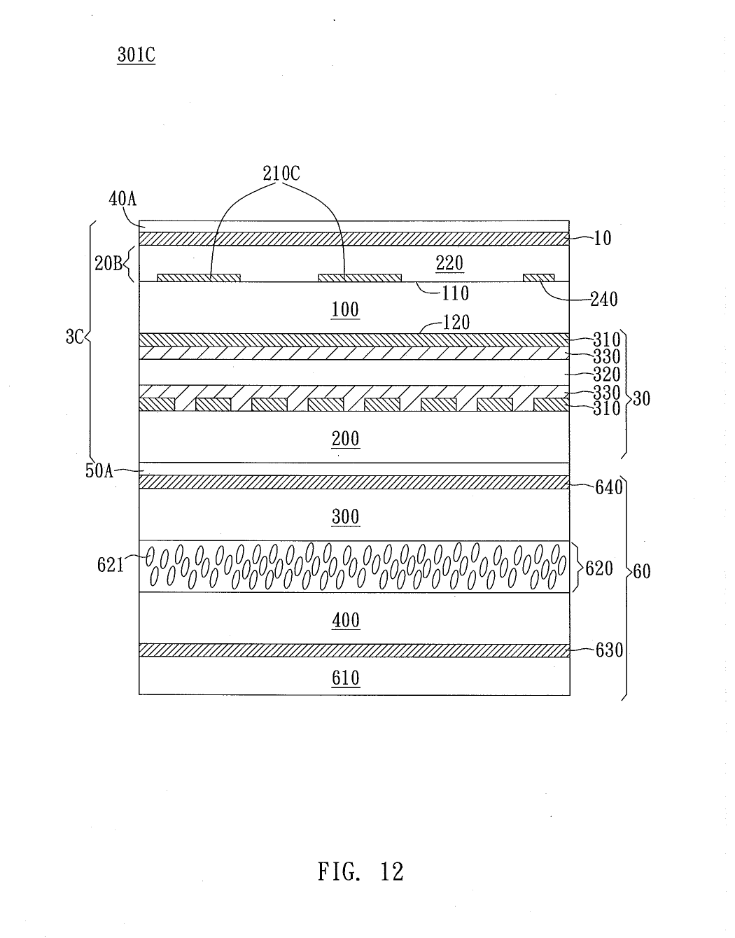

Please refer to FIG. 12; FIG. 12 is a cross-sectional view of another embodiment of the stereoscopic image control module 3C and the stereoscopic display device 301C of the present invention. As shown in FIG. 12, the stereoscopic image control module 3C has the touch composite layer 20B; the assembly structure of the polarizing layer 10 and the transparent optical layer 40A of the stereoscopic image control module 3C is the same as the assembly structure of the stereoscopic image control module 1D and not elaborated hereinafter. It is noted that the touch composite layer 20B as shown in FIGS. 10, 11, and 12 are usually called One-Layer or Single-Layer structure, and the touch electrodes 210C are disposed on the first surface 110 or the upper surface of first substrate 100.

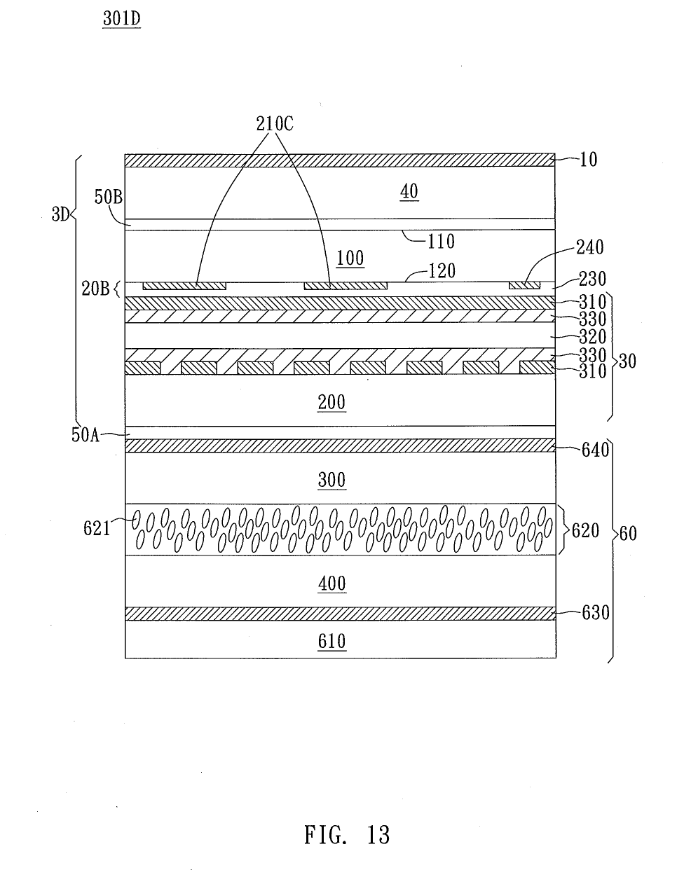

Please refer to FIG. 13; FIG. 13 is a cross-sectional view of another embodiment of the stereoscopic image control module and the stereoscopic display device of the present invention. As shown in FIG. 13, the touch electrodes 210C of the touch composite layer 20B of the stereoscopic image control module 3D is disposed on the second surface 120. It is noted that the second protection layer 230 connects the grating composite layer 30 so as to avoid the touch electrodes 210C on the second surface 120 to be contacted by the grating control electrodes 310. In practical applications, the structure of stereoscopic image control module 3C is a stack structure by disposing components in layer-by-layer manner to simplify the manufacturing process. In addition, the assembly structure of the optical glue layer 50B, the polarizing layer 10, and the transparent optical layer 40 of the stereoscopic image control module 3D is the same as the assembly structure of the stereoscopic image control module 3A and not elaborated hereinafter.

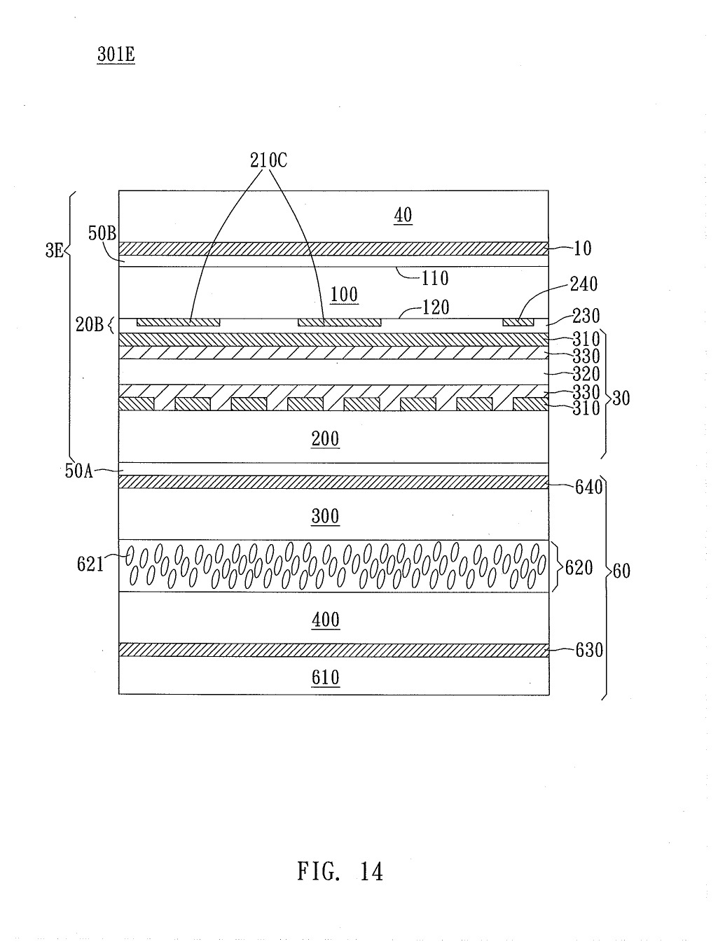

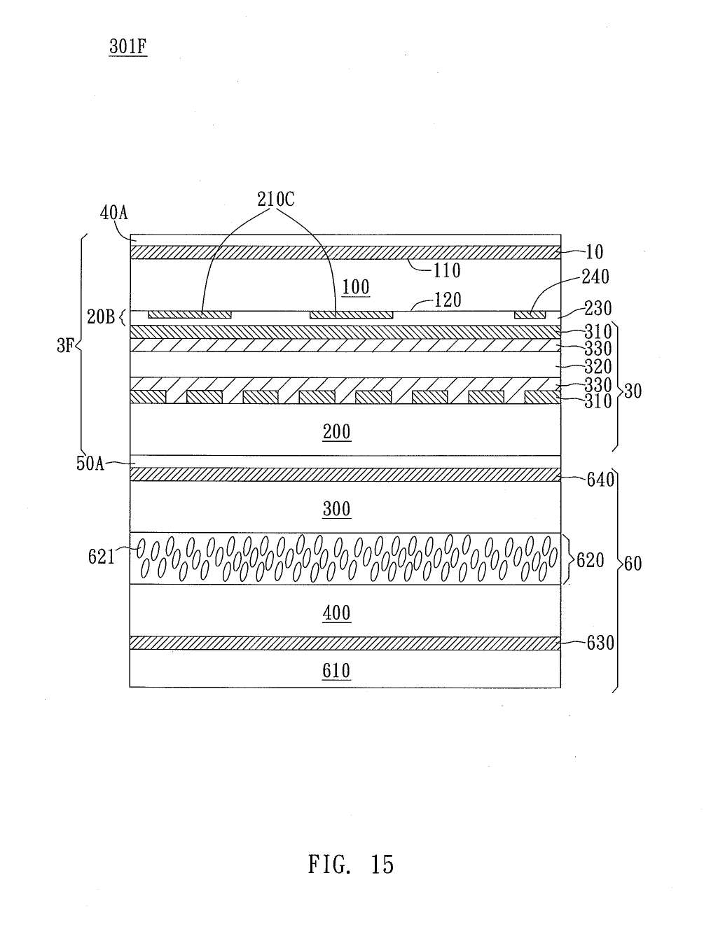

As to the embodiments of the stereoscopic image control modules 3E/3F and the stereoscopic display devices 301E/301F respectively shown in FIGS. 14 and 15, the stereoscopic image control modules 3E and 3F similarly have the touch composite layer 20B which is disposed on the second surface 120. In addition, the assembly structure of the optical glue layer 50B, the polarizing layer 10, and the transparent optical layer 40 of the stereoscopic image control module 3E is the same as the assembly structure of the stereoscopic image control module 3B. The assembly structure of the polarizing layer 10 and the transparent optical layer 40A of the stereoscopic image control module 3F is the same as the assembly structure of the stereoscopic image control module 3C and not elaborated hereinafter. It is noted that the touch composite layer 20B as shown in FIGS. 13, 14, and 15 are usually called One-Layer or Single-Layer structure, and the touch electrodes 210C are disposed on the second surface 120 or the lower surface of first substrate 100.

In comparison with prior arts, the stereoscopic image control module and the stereoscopic display device of the present invention utilize the first substrate serving as a common substrate to decrease the amount of substrates so as to be light and thin. It is noted that the first substrate is the common substrate of the touch composite layer and the grating composite layer. In other words, the touch composite layer and the grating composite layer jointly utilize the first substrate to dispose components so as to decrease the thickness of the whole module and to effectively decrease usage rate of the glue. It is noted that the stereoscopic image control module improves manufacturing process to solve the problems of cost and yield without influencing touch technology and display technique.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A stereoscopic image control module, comprising:
a first substrate having a first surface and a second surface opposite to the first surface;
a touch composite layer disposed on at least one of the first surface and the second surface, the touch composite layer comprising a plurality of touch electrodes; and
a grating composite layer disposed on the second surface, the grating composite layer comprising a plurality of grating control electrodes and a grating layer.

2. The stereoscopic image control module of claim 1, wherein the touch composite layer further comprises:
a first protection layer covering the touch electrodes disposed on the first surface.

3. The stereoscopic image control module of claim 1, wherein the touch electrodes are disposed on the first surface in a transverse direction and a longitudinal direction.

4. The stereoscopic image control module of claim 1, wherein some of the touch electrodes are disposed on the first surface, and the rest of the touch electrodes are disposed on the second surface of the first substrate.

5. The stereoscopic image control module of claim 4, wherein an extending direction of the touch electrodes disposed on the first surface is perpendicular to an extending direction of the touch electrodes disposed on the second surface.

6. The stereoscopic image control module of claim 1, wherein the touch electrodes are disposed on the first surface or the second surface.

7. The stereoscopic image control module of claim 1, wherein the touch composite layer further comprises:
a second protection layer covering the touch electrodes on the second surface.

8. The stereoscopic image control module of claim 7, wherein the second protection layer is connected to the grating composite layer.

9. The stereoscopic image control module of claim 1, wherein the touch composite layer further comprises:
a fan-out unit connected to the touch electrodes.

10. The stereoscopic image control module of claim 1, wherein the grating composite layer further comprises:
a second substrate disposed to face the second surface of the first substrate, wherein some of the grating control electrodes are disposed on the second substrate and the rest of the grating control electrodes are disposed on the second surface.

11. The stereoscopic image control module of claim 1, further comprising:
a polarizing layer disposed outside of the touch composite layer.

12. The stereoscopic image control module of claim 10, further comprising:
a transparent optical layer disposed between the touch composite layer and the polarizing layer or outside of the polarizing layer.

13. The stereoscopic image control module of claim 11, wherein the transparent optical layer is a lens layer, a transparent glue layer, or arbitrary transparent layer.

14. The stereoscopic image control module of claim 11, further comprising:
an optical glue layer disposed between the touch composite layer and the transparent optical layer or between the touch composite layer and the polarizing layer.

15. A stereoscopic display device, comprising:
the stereoscopic image control module of claim 10; and
a display module disposed corresponding to the stereoscopic image control module.

16. The stereoscopic display device of claim 15, wherein the display module comprises:
a backlight module disposed corresponding to the second substrate.

17. The stereoscopic display device of claim 16, wherein the display module further comprises:
an optical modulation layer disposed between the backlight module and the stereoscopic image control module, the optical modulation layer having a plurality of optical units.

18. The stereoscopic display device of claim 17, wherein the display module further comprises:
a third substrate disposed on the second substrate and connected to the stereoscopic image control module.

19. The stereoscopic display device of claim 18, wherein the display module further comprises:
a fourth substrate; the optical modulation layer is disposed between the fourth substrate and the third substrate.

20. The stereoscopic display device of claim 19, wherein the display module further comprises:
a first polarizing layer disposed between the fourth substrate and the backlight module; and
a second polarizing layer disposed between the second substrate and the third substrate.
